(19) United States
(12) Patent Application Publication
(10) Pub. No.: US 2026/0141690 A1
(43) Pub. Date: May 21, 2026

(54) LAYER-WISE KNOWLEDGE DISTILLATION FOR VISION LANGUAGE MODELS

(71) Applicant: NVIDIA Corporation, Santa Clara, CA (US)

(72) Inventors: Yueh-Hua Wu, Taipei City (TW); Byung-Kwan Lee, Daejeon (KR); Ryo Hachiuma, Taipei City (TW); Yu-Chiang Wang, Taipei City (TW)

(21) Appl. No.: 19/256,885

(22) Filed: Jul. 1, 2025

Related U.S. Application Data
(60) Provisional application No. 63/721,737, filed on Nov. 18, 2024.

(51) Int. Cl. G06V 10/774; G06V 10/764

(52) U.S. Cl. CPC G06V 10/774; G06V 10/764

(57) ABSTRACT

Techniques are provided for layer-wise knowledge distillation for vision language models (VLMs). In one or more embodiments, techniques include obtaining an initial compact VLM with multiple intermediate layers and a teacher VLM with multiple intermediate layers, performing, for one or more training iterations, adaptive layer matching to establish student-teacher layer pairs, computing knowledge distillation losses for the established pairs, and updating learnable parameters of the compact VLM based on the computed losses.

### CLAIM OF PRIORITY

This application claims the benefit of U.S. Provisional Application No. 63/721,737, titled “VLsI: Verbalized Layers-To-Interactions From Large To Small Vision Language Models” and filed Nov. 18, 2024, the entire contents of which are incorporated herein by reference.

### BACKGROUND

The integration of large language models (LLMs) with vision-language models (VLMs) has significantly enhanced the interpretive and processing capabilities of visual systems. By leveraging architectures such as Contrastive Language-Image Pre-training (CLIP)-aligned vision encoders, VLMs have achieved unprecedented performance in understanding and responding to visual inputs. At the core of these advancements is visual instruction tuning, which pairs images with question-answer text to provide VLMs with rich, instruction-based training.

While new performance standards for vision-language tasks have been established by large VLMs, the extensive hardware resources they require prevent them from being deployed in many real-world, resource-constrained environments. Traditional approaches to designing high-performing, efficient VLMs capable of handling complex visual tasks without requiring extensive hardware resources often involve adding specialized modules or modifying model architectures. However, such approaches introduce significant engineering complexity and can lead to compatibility issues during deployment-particularly for on-device applications where low-latency and memory efficiency are paramount. Furthermore, the performance of VLMs that result from such approaches often falls short, as recent evaluations using standardized benchmarks have revealed an inability to perform advanced visual reasoning tasks.

### BRIEF DESCRIPTION OF THE DRAWINGS

Subject matter of the present disclosure is described in detail below with reference to the attached drawing figures. Features described and/or illustrated herein can be used alone and/or combined in different combinations. The attached drawings illustrate the following:

FIG. 1 illustrates a flowchart of a method for training a compact vision language model (VLM) via layer-wise knowledge distillation, in accordance with an embodiment;

FIG. 2A illustrates a flowchart of a method for training one or more verbalizers, in accordance with an embodiment;

FIG. 2B illustrates a block diagram of system suitable for use in training one or

more verbalizers, in accordance with an embodiment;

FIG. 2C illustrates a flowchart of a method for performing layer-wise knowledge distillation, in accordance with an embodiment;

FIG. 2D illustrates a flowchart of a method for performing adaptive layer matching, in accordance with an embodiment;

FIG. 2E illustrates a block diagram of system suitable for use in performing layer-wise knowledge distillation, in accordance with an embodiment;

FIG. 3A provides an algorithm for adaptive layer matching and loss computation during layer-wise knowledge distillation, in accordance with an embodiment;

FIG. 3B illustrates layer matching for layer-wise knowledge distillation, in accordance with an embodiment;

FIGS. 3C and 3D provide layer-matching probability distributions between student VLM layers and teacher VLM layers before and after layer-wise knowledge distillation;

FIG. 4 illustrates an example parallel processing unit suitable for use in implementing one or more embodiments of the present disclosure;

FIG. 5A is a conceptual diagram of a processing system, implemented using the PPU of FIG. 4, suitable for use in implementing one or more embodiments of the present disclosure;

FIG. 5B illustrates an exemplary system in which the various architecture and/or functionality of the various previous embodiments may be implemented;

FIG. 5C illustrates components of an exemplary system that can be used to train and utilize machine learning, suitable for use in implementing one or more embodiments of the present disclosure; and

FIG. 6 illustrates an exemplary streaming system suitable for use in implementing one or more embodiments of the present disclosure.

### DETAILED DESCRIPTION

The present invention provides network architectures and machine learning techniques that support generating, from a single pretrained neural network, one or more compressed neural networks. The network architectures and machine learning techniques of the present disclosure support neural network compression and acceleration and the provision of families of compressed VLMs that maintain exceptional performance while simultaneously limiting training cost through data-efficient training techniques. The network architectures and machine learning techniques of the present disclosure implement innovative, natural language-based distillation processes to efficiently transfer knowledge from large to small VLMs. Unlike traditional distillation methods, which often directly imitate outputs from a larger model, one or more network architectures and machine learning techniques of the present disclosure implement a layer-wise approach where each intermediate layer generates output in a language space (e.g., a natural language space), enhancing interpretability and alignment.

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles, semi-autonomous vehicles (e.g., in one or more advanced driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training or updating, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing generative AI operations, systems implemented using large language models (LLMs), systems implemented using vision language models (VLMs), systems for performing light transport simulation, systems for performing collaborative content creation for 3D assets, systems implemented at least partially using cloud computing resources, and/or other types of systems.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examplessuch as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

One or more systems and methods described herein provide for training compact vision language models (VLMs) through knowledge transfer from larger, pre-trained VLMs. In particular, one or more systems and methods described herein leverage natural language-based distillation to efficiently transfer knowledge from larger VLMs to smaller VLMs, thereby creating high-performing yet computationally efficient VLMs capable of handling complex visual tasks without requiring extensive hardware resources. Network architectures and machine learning techniques described herein thereby enable the deployment of advanced VLMs in resource-constrained environments such as mobile devices and autonomous robots.

One or more embodiments provide for training a compact VLM via three phases: verbalization, interaction, and reinforcement. In the verbalization phase, verbalizers are incorporated into intermediate layers of both a teacher VLM (i.e., a larger, pre-trained VLM) and a student VLM (the compact VLM being trained). The verbalizers are then trained to project intermediate embedding space representations (i.e., outputs of intermediate layers of the student VLM and of the teacher VLM) to a token space. In one or more embodiments, the token space is a natural language space. In the interaction phase, a distillation process is employed to transfer knowledge from the teacher VLM to the student VLM. During the interaction phase, adaptive layer matching is carried out to pair intermediate layers of the student VLM with intermediate layers of the teacher VLM, and knowledge distillation losses are computed from the token space outputs of paired intermediate layers. The knowledge distillation process employed during the interaction phase thereby leverages the trained verbalizers to allow for knowledge distillation losses to be computed, e.g., in the natural language space rather than an embedding space native to intermediate layers of the student and teacher VLMs. During the reinforcement phase, an end-to-end supervised learning process is carried out to fine-tune the student VLM backbone produced by the interaction phase. The reinforcement phase facilitates integration, across layers of the student VLM backbone, of the knowledge acquired during the interaction phase and enhances the task-specific performance of the resulting trained compact VLM. The three-phase process according to the one or more embodiments represents a data-efficient training technique that limits training cost (as compared to training a compact VLM from scratch) while yielding compact VLMs that provide exceptional performance on downstream visual reasoning tasks.

According to one or more embodiments, a method for training a compact vision language model (VLM) via distillation from a teacher VLM is provided. The method includes obtaining an initial compact VLM including a plurality of compact VLM intermediate layers and obtaining the teacher VLM, the teacher VLM comprising a plurality of teacher VLM intermediate layers. The method further includes performing, for each of a plurality of training iterations: (i) adaptive layer matching to establish a plurality of student-teacher layer pairs, each student-teacher layer pair comprising a compact VLM intermediate layer and a teacher VLM intermediate layer, (ii) student-teacher layer pair knowledge distillation loss computation to compute, for one or more student-teacher layer pairs, a knowledge distillation loss, and (iii) student VLM parameter updating to update, for one or more compact VLM intermediate layers, learnable parameters based on the one or more knowledge distillation losses.

According to an embodiment, the method further includes incorporating verbalizers into one or more of the plurality of compact VLM intermediate layers of the initial compact VLM, incorporating verbalizers into one or more of the plurality of teacher VLM intermediate layers, and training the verbalizers incorporated into the initial compact VLM and the verbalizers incorporated into the teacher VLM. According to an embodiment, training the verbalizers incorporated into the initial compact VLM and the verbalizers incorporated into the teacher VLM includes performing, for each of a plurality of training iterations: (a) generating, by one or more of the verbalizers incorporated into the initial compact VLM and by one or more of the verbalizers incorporated into the teacher VLM, a token space prediction, (b) computing losses based on the token space predictions and a ground truth, and (c) updating, based on the computed losses, learnable parameters of the one or more of the verbalizers incorporated into the initial compact VLM and of the one or more of the verbalizers incorporated into the teacher VLM.

According to an embodiment of the method, the knowledge distillation losses computed for the one or more teacher-student layer pairs are computed by comparing a token space prediction generated by a respective compact VLM intermediate layer and a token space prediction generated by a respective teacher VLM intermediate layer. According to an embodiment, the knowledge distillation losses are KL divergences.

According to an embodiment of the method, the adaptive layer matching comprises determining, for one or more of the plurality of compact VLM intermediate layers, a search range comprising one or more teacher VLM intermediate layers. According to an embodiment, the search range for the one or more of the plurality of compact VLM intermediate layers iₛ=0^{th}, 1^{st}, . . . , (tₛ−1)^{th} layer includes one or more of the plurality of teacher VLM intermediate layers iₗ=0^{th}, 1^{st}, . . . , (tₗ−1)^{th} selected such that a layer iₗ=j paired with a layer of iₛ and a layer iₗ=k paired with a layer of iₛ−1 satisfies j>k. According to an embodiment, a teacher VLM intermediate layer paired with a compact VLM intermediate layer is selected by sampling from a distribution inversely proportional to a KL divergence a token space output of the compact VLM intermediate layer and the token space outputs of the teacher VLM intermediate layers in the search space. According to an embodiment, the distribution is computed using a softmax of the scaled, negative KL divergence values.

According to one or more embodiments, a non-transitory computer readable medium is provided having stored thereon processor executable instructions that, when executed by processing circuitry, cause the processing circuitry to perform the method for training a compact vision language model (VLM) via distillation from a teacher VLM, including any embodiment thereof.

According to one or more embodiments, a system for training a compact vision language model (VLM) via distillation from a teacher VLM is provided. The system includes processing circuitry configured to obtain an initial compact VLM including a plurality of compact VLM intermediate layers and obtain the teacher VLM, the teacher VLM comprising a plurality of teacher VLM intermediate layers. The processing circuitry is further configured to perform, for each of a plurality of training iterations: (i) adaptive layer matching to establish a plurality of student-teacher layer pairs, each student-teacher layer pair comprising a compact VLM intermediate layer and a teacher VLM intermediate layer, (ii) student-teacher layer pair knowledge distillation loss computation to compute, for one or more student-teacher layer pairs, a knowledge distillation loss, and (iii) student VLM parameter updating to update, for one or more compact VLM intermediate layers, learnable parameters based on the one or more knowledge distillation losses. The system additionally includes one or more memories to store parameters of the compact VLM.

According to an embodiment of the system, the processing circuitry is further configured to incorporate verbalizers into one or more of the plurality of compact VLM intermediate layers of the initial compact VLM, incorporate verbalizers into one or more of the plurality of teacher VLM intermediate layers, and train the verbalizers incorporated into the initial compact VLM and the verbalizers incorporated into the teacher VLM. According to an embodiment, the processing circuitry is configured to train the verbalizers incorporated into the initial compact VLM and the verbalizers incorporated into the teacher VLM by performing, for each of a plurality of training iterations: (a) generating, by one or more of the verbalizers incorporated into the initial compact VLM and by one or more of the verbalizers incorporated into the teacher VLM, a token space prediction, (b) computing losses based on the token space predictions and a ground truth, and (c) updating, based on the computed losses, learnable parameters of the one or more of the verbalizers incorporated into the initial compact VLM and of the one or more of the verbalizers incorporated into the teacher VLM.

According to an embodiment of the system, the knowledge distillation losses computed for the one or more teacher-student layer pairs are computed by comparing a token space prediction generated by a respective compact VLM intermediate layer and a token space prediction generated by a respective teacher VLM intermediate layer. According to an embodiment, the knowledge distillation losses are KL divergences.

According to an embodiment of the system, the adaptive layer matching comprises determining, for one or more of the plurality of compact VLM intermediate layers, a search range comprising one or more teacher VLM intermediate layers. According to an embodiment, the search range for the one or more of the plurality of compact VLM intermediate layers is =0^{th}, 1^{st}, . . . , (tₛ−1)^{th} layer includes one or more of the plurality of teacher VLM intermediate layers iₗ=0^{th}, 1^{st}, . . . , (tₗ−1)^{th} selected such that a layer iₗ=j paired with a layer of is and a layer iₗ=k paired with a layer of iₛ−1 satisfies j>k. According to an embodiment of the system, a teacher VLM intermediate layer paired with a compact VLM intermediate layer is selected by sampling from a distribution inversely proportional to a KL divergence a token space output of the compact VLM intermediate layer and the token space outputs of the teacher VLM intermediate layers in the search space. According to an embodiment of the system, the distribution is computed using a softmax of the scaled, negative KL divergence values.

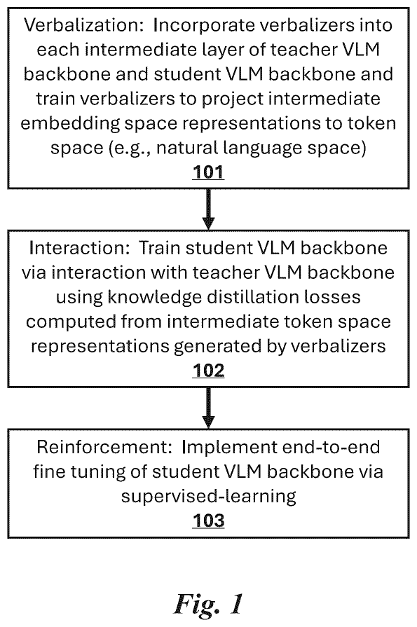

FIG. 1 illustrates a flowchart of a method 100 for training a lightweight VLM backbone, in accordance with an embodiment. Each block of method 100, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 100 may be executed by any one system, or any combination of systems, including, but not limited to, those described herein. Furthermore, persons of ordinary skill in the art will understand that any system that performs method 100 is within the scope and spirit of embodiments of the present disclosure.

At verbalization phase 101, method 100 incorporates verbalizers into one or more (e.g., each) intermediate layers of both (i) a teacher VLM backbone (i.e., a large VLM backbone from which knowledge is to be transferred) and (ii) a student VLM backbone (i.e., the lightweight VLM backbone that is to be trained via knowledge transfer from the teacher VLM backbone). In one or more embodiments, the verbalizers each include both (a) a lightweight, trainable feed forward network (FFN) and (b) a language head selected from the teacher VLM backbone or the student VLM backbone. In one or more embodiments, the language heads are each a multi-layer perceptron (MLP). After the verbalizers are incorporated into each intermediate layer of the teacher and student VLM backbones, method 100 trains each verbalizer to project an intermediate embedding space representation (i.e., an output of an intermediate layer of the teacher or student VLM backbone) to a token space (e.g., a natural language space).

In one or more embodiments, the teacher VLM backbone is a transformer backbone that includes Nₜ transformer blocks, or layers, and the student VLM backbone is a transformer backbone that includes Nₛ transformer blocks, or layers, where Nₛ≤Nₜ. One or more (e.g., each) of the Nₜ layers and one or more (e.g., each) of the Nₛ layers include a multi-head attention (MHA) sub-block and a multi-layer perceptron (MLP) sub-block. One or more (e.g., each) respective MHA sub-blocks perform an MHA operation for an input X as follows:

$$MHA ( X ) = Concat ( {head}_{1} , ... {head}_{L} ) \cdot {W}^{O}$$

$${head}_{i} = Attn ( {XW}^{Q , i} , {XW}^{K , i} , {XW}^{V , i} )$$

where W^{Q,i}, W^{K,i}, W_{V,i}∈ [symbol] ^{d}^{_{head}}^{×d}^{_{model}}, W^{O}∈ [symbol] ^{Ld}^{_{head}}^{×d}^{_{model}}, d_{head} is a size of a single attention head, d_{model} is an embedding dimension of the respective VLM backbone, and L is a total number of attention heads. One or more (e.g., each) respective MLP sub-blocks perform an MLP operation for an input X as follows:

$$MLP ( X ) = δ ( X \cdot {W}_{1}^{T} ) \cdot {W}_{2}$$

where W₁ and W₂ are associated weight matrices in the respective MLP layer, W₁, W₂∈ [symbol] ^{d}^{_{hidden}}^{×d}^{_{model}}, d_{model} is an embedding dimension of the respective VLM backbone, d_{hidden} is an MLP hidden layer dimension, and δ(·) is a non-linear activation function. In one or more embodiments, the values of d_{model}, d_{head}, and d_{hidden} for the student VLM backbone are less than or equal to the corresponding values of d_{model}, d_{head}, and d_{hidden} for the teacher VLM backbone.

During interaction phase 102, method 100 performs a distillation process that leverages the natural language output from intermediate layers to transfer knowledge from the teacher VLM to the student VLM. Interaction phase 102 involves performing a number of training iterations, each of which includes both (i) an adaptive layer matching phase and (ii) parameter update phase. During the adaptive layer matching phase, each intermediate layer of the student VLM is matched to a corresponding target layer of the teacher VLM. Then, during the parameter update phase, a knowledge distillation loss (KDL) is computed for each respective intermediate layer of the student VLM based on a comparison of a token space output of the respective intermediate layer of the student VLM and a token space output of a corresponding target layer of the teacher VLM. Parameters of both the student VLM backbone and of the verbalizers incorporated into the intermediate layers of the student VLM backbone are updated based on the computed KDLs, thereby concluding a single training iteration. Thereafter, additional training iterations are performed.

In reinforcement phase 103, method 100 performs an end-to-end supervised learning process to fine-tune the student VLM backbone resulting from interaction phase 102. In at least one embodiment, reinforcement phase 103 is carried out using the same training dataset utilized for verbalization phase 101 and/or interaction phase 102.

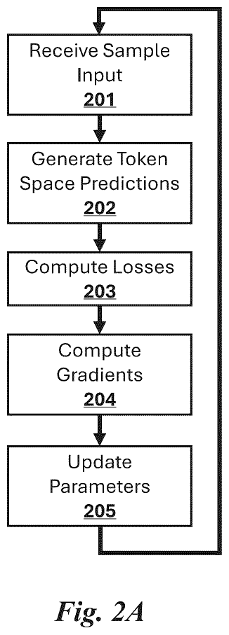

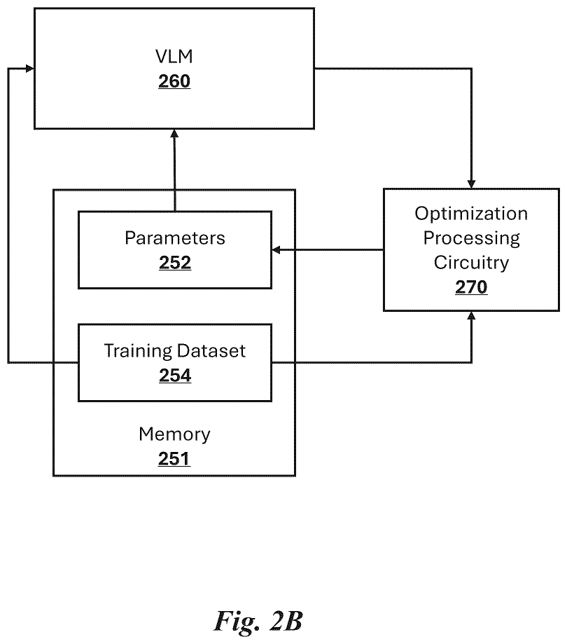

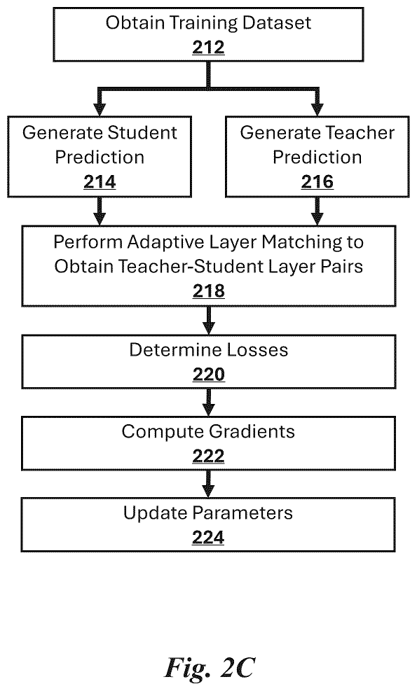

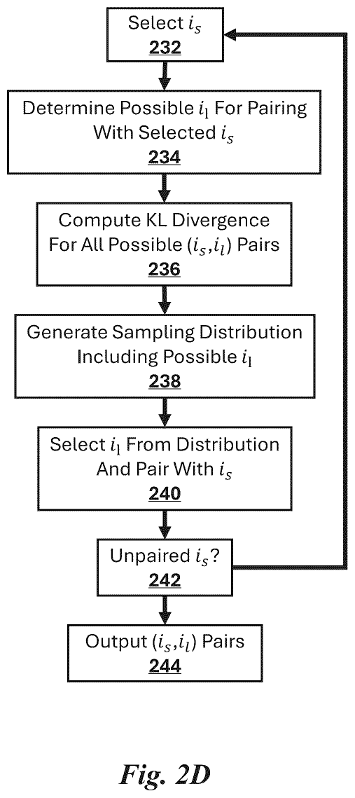

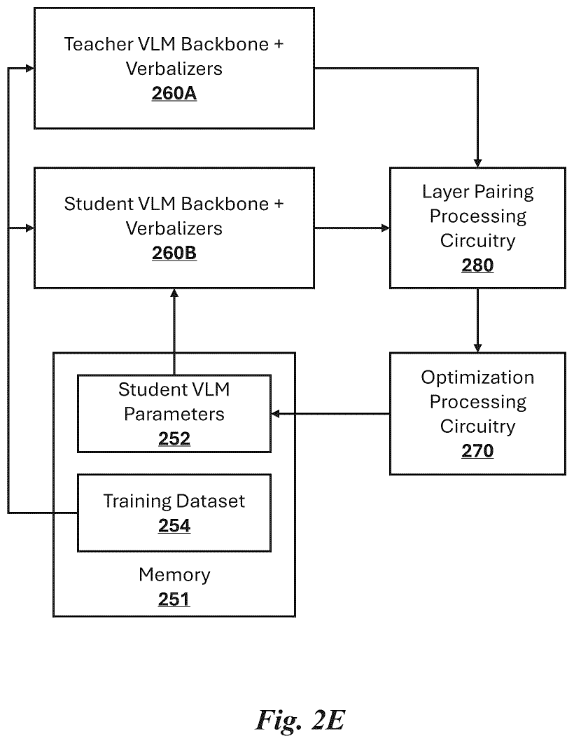

FIG. 2A illustrates a flowchart of a method 200 for training a verbalizer, e.g., a verbalizer incorporated into a VLM backbone, to project an intermediate embedding space representation to a token space, in accordance with an embodiment. Each block of method 200, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 200 may be executed by any one system, or any combination of systems, including, but not limited to, those described herein. Furthermore, persons of ordinary skill in the art will understand that any system that performs method 200 is within the scope and spirit of embodiments of the present disclosure.

Method 200 receives, at 201 by a modified teacher VLM backbone and/or by a modified student VLM backbone (e.g., the teacher and student VLM backbones into which the verbalizers are incorporated during the verbalization step of method 100), a sample input (i.e., from a training dataset) and generates, at 202 by the modified teacher VLM backbone and/or by the modified student VLM backbone, output. During the generation of the output by the modified teacher VLM backbone and/or by the modified student VLM backbone, each intermediate layer of the teacher VLM backbone and/or of the student VLM backbone generates intermediate layer output in an embedding space (i.e., an intermediate embedding space representation) and a corresponding verbalizer projects the generated intermediate layer output from the embedding space to the token space to provide a token space prediction.

At 203, method 200 computes a loss for each respective verbalizer by comparing the token space prediction generated by the respective verbalizer to a ground truth label corresponding to the sample input received at 201. In at least one embodiment, one or more losses (e.g., each loss) computed at 203 includes a cross-entropy loss that compares the token space prediction generated by the respective verbalizer to the corresponding ground truth label. At 204, method 200 computes, for each respective verbalizer, gradients of a corresponding loss computed at 203 with respect to parameters of the respective verbalizer. At 205, method 200 updates the parameters of each respective verbalizer based on the computed gradients. Method 200 then repeats, using different sample input, until a convergence criteria is satisfied or another condition is met that causes method 200 to conclude (e.g., no additional sample input remains in the training data). In at least one embodiment, the gradients computed at 204 are an average of gradients computed for each of individual samples in a training batch.

FIG. 2B illustrates a block diagram of an example system 250B suitable for use in implementing some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the system 250B is within the scope and spirit of embodiments of the present disclosure.

System 250B is suitable for use in training one or more verbalizers, e.g., by performing method 200 of FIG. 2A. System 250B includes a memory 251 that stores parameters 252 and training dataset 254, a VLM 260, and optimization processing circuitry 270.

In various embodiments, memory 251 includes volatile memory, non-volatile memory, or a combination thereof. In one or more embodiments, memory 251 stores program code that, when executed, implements the functionality of the VLM 260. Memory 251 stores parameters 252 that include weights of the VLM 260 (e.g., frozen weights of a teacher VLM backbone and learnable weights of verbalizers incorporated therein or frozen weights of a student VLM backbone and learnable weights of verbalizers incorporated therein). Memory 251 also stores training dataset 254, which provides input data used to train the verbalizers of VLM 260, e.g., by carrying out method 200. In one or more embodiments, training dataset 254 includes pairs of visual and textual inputs along with corresponding target outputs (i.e., “ground truth” outputs).

VLM 260 can be, e.g., a teacher VLM backbone into which verbalizers have been incorporated (e.g., during verbalization phase 101 of method 100) or a student VLM backbone into which verbalizers have been incorporated. VLM 260 processes inputs from the training dataset 254 according to parameters 252 and generates outputs in response to the inputs. The outputs include a plurality of outputs (e.g., Nₜ outputs for a teacher VLM having Nₜ layers or Nₛ outputs for a student VLM having Nₛ layers) provided by the verbalizers incorporated therein. The outputs generated by the verbalizers incorporated into VLM 260 are provided to optimization processing circuitry 270.

Optimization processing circuitry 270 evaluates the performance of the verbalizers incorporated into VLM 260 by comparing the outputs generated by the verbalizers to target outputs (i.e., “ground truth”) included in training dataset 254. Optimization processing circuitry 270 computes, e.g., using a loss function, error values, or losses, that quantify the difference between the outputs provided by the verbalizers and the target outputs included in training dataset 254. Optimization processing circuitry 270 uses the computed losses to compute, via backpropagation, gradients of the computed losses with respect to the learnable weights of the verbalizers (which are, e.g., stored as a subset of parameters 252), and further uses the computed gradients to compute parameter updates for the learnable weights of the verbalizers.

During verbalizer training (e.g., in accordance with method 200 of FIG. 2A), VLM 260 processes inputs from training dataset 254 according to a current state of parameters 252, the outputs generated by the verbalizers of VLM 260 are passed to optimization processing circuitry 270, and optimization processing circuitry 270 computes parameter updates used to update the parameters of the verbalizers of VLM 260, thereby adjusting the behavior of the verbalizers. The process is repeated in an iterative fashion, gradually improving the performance of the verbalizers.

FIG. 2C illustrates a flowchart of a method 210 for transferring knowledge from a teacher VLM backbone to a student VLM backbone via a layer-wise approach, in accordance with an embodiment. Each block of method 210, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 210 may be executed by any one system, or any combination of systems, including, but not limited to, those described herein. Furthermore, persons of ordinary skill in the art will understand that any system that performs method 210 is within the scope and spirit of embodiments of the present disclosure.

Method 210 transfers knowledge from a teacher VLM backbone to a student VLM backbone via a layer-wise approach in which each intermediate layer of the student VLM backbone is matched to a corresponding target layer of the teacher VLM backbone and the student VLM backbone is trained using KDLs computed for matched layer pairs. In one or more embodiments, the KDLs computed for matched layer pairs are KL divergences between a token space student prediction (i.e., a token space representation generated by projecting, by a verbalizer (e.g., a verbalizer trained via method 200), an embedding space output of a student layer to the token space) and a token space teacher prediction (i.e., a token space representation generated by projecting, by a verbalizer (e.g., a verbalizer trained via method 200), an embedding space output of a teacher layer to the token space).

Method 210 obtains, at 212, a training dataset that includes a number of sample inputs. Each sample input includes a textual component and a visual component. Method 210 generates, by processing a sample input from the training dataset by the modified student VLM backbone, a student prediction at 214. Method 210 also generates, by processing a sample input from the training dataset by the modified teacher VLM backbone, a teacher prediction at 216. Each of the student predictions generated at 214 and the teacher prediction generated at 216 include both (i) a final token space output and (ii) a plurality of intermediate token space outputs.

Method 210 performs, at 218, adaptive layer matching to obtain teacher-student layer pairs by matching intermediate layers of the student VLM backbone with intermediate layers of the teacher VLM backbone. Adaptive layer matching allows the student VLM backbone to learn a reasoning progression from the teacher VLM backbone. In at least one embodiment, the number of target layers in the teacher VLM backbone and in the student VLM backbone are designated as tₗ and tₛ, respectively, with individual layers being designated as iₗ=0^{th}, 1^{st}, . . . , (tₗ−1)^{th} and is =0^{th}, 1^{st}, . . . , (tₛ−1)^{th}, where tₛ≤tₗ. Adaptive layer matching at 218 iterates over the tₛ layers in the student VLM backbone, ensuring that each layer has a corresponding target layer in the teacher VLM backbone (though layers in the teacher VLM backbone may not have corresponding layers in the student VLM backbone as tₛ≤tₗ).

In at least one embodiment, the adaptive layer matching at 218 employs a strategy that respects two key criteria: (i) order preservation: each layer j (of the teacher VLM backbone) matched with layer i (from the student VLM backbone) must be deeper than layer k (of the teacher VLM backbone) matched with layer i−1, ensuring j>k; and (ii) layer-wise exploration (e.g., via Multinomial Sampling): to encourage novel and effective configurations for layer matching, layers are sampled based on a distribution that is inversely proportional to the KL divergence between the verbal distributions of the matched layers in the large and small VLMs. In at least one embodiment, the sampling distribution is computed using a softmax of the scaled, negative KL divergence values. As a result, each iₛ is not necessarily matched with the it that provides the lowest pairwise KL divergence value. It has been found that always matching each iₛ with the iₗ that provides the lowest pairwise KL divergence value can reduce exploration by a sufficient amount to cause convergence to suboptimal solutions, and therefore, sampling from a distribution inversely proportional to the KL divergence value can encourage exploration, explore potentially superior pairings, and enhance the robustness of the pairing strategy.

Method 210 determines, at 220, losses between the outputs of the teacher layer and the student layer of each teacher-student layer pair obtained at 218. In at least one embodiment, the losses are determined by computing the average KL divergence for each teacher-student layer pair obtained at 218. In at least one embodiment, the losses are determined by re-using the average KL divergences used for constructing the sampling distributions used during the adaptive layer matching at 218. Method 210 then computes, at 222, gradients of the computed losses with respect to the parameters of the corresponding student layer and its associated verbalizer and updates, at 224, said parameters. Method 210 repeats using different training samples from the training dataset obtained at 212.

In at least one embodiment, the adaptive layer matching at 218 comprises computing average pairwise KL divergences for all possible (iₛ, iₗ) pairs and selecting, for each iₛ, an iₗ from an available search space (e.g., determined under the constraint of order preservation, described above) by sampling from a distribution determined using the average pairwise KL divergences computed at 218. Thereafter, at 220-224, the parameters of each is are updated using the corresponding average pairwise KL divergence, i.e., corresponding to the selected it, computed at 218 as the KD loss.

FIG. 2D illustrates a flowchart of a method 230 for performing adaptive layer matching, in accordance with an embodiment. Each block of method 230, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 230 may be executed by any one system, or any combination of systems, including, but not limited to, those described herein. Furthermore, persons of ordinary skill in the art will understand that any system that performs method 230 is within the scope and spirit of embodiments of the present disclosure.

Method 230 selects, at 232, a student layer is. At 234, method 230 determines all possible teacher layers it for pairing with the selected student layer is. In one or more embodiments, the set of all possible teacher layers is determined to ensure order preservation (such that the layer of the teacher VLM backbone matched to the selected layer of the student VLM backbone is always deeper than the all layers of the teacher VLM backbone matched to preceding layers of the student VLM backbone). At 236, method 230 computes KL divergences for all possible student-teacher layer pairs determined at 234.

At 238, method 230 generates a sampling distribution based on the KL divergences computed at 236. In at least one embodiment, the sampling distribution is inversely proportional to the KL divergence values computed in step 236. In at least one embodiment, the sampling distribution is computed using a softmax function of the scaled, negative KL divergence values computed at 236. In one or more embodiments, the softmax function uses a temperature value to compute the sampling distribution. In one or more embodiments, the temperature value is progressively decreased from one iteration of method 230 to the next. In one or more embodiments, the temperature value is decreased in a step-wise manner during a layer-wise knowledge distillation technique (e.g., during method 210 of FIG. 2C). The temperature value has a significant impact on the probability that a given teacher layer will be paired with a specific student layer. When the temperature is relatively high, the sampling distribution is relatively uniform, thereby promoting exploration of different teacher-student layer pairings (as the KL divergence values will have less impact on the probability of a given teacher layer being paired with a specific student layer). Exploration of different pairings is particularly beneficial early in the training process when optimal pairings are not yet known. When the temperature is relatively low (e.g., as the result of its being decreased during training), the sampling distribution is less uniform with peaks corresponding to student-teacher pairs having lower KL divergence values.

At 240, method 230 selects a teacher layer based on the sampling distribution generated and pairs it with the selected student layer is. By using a distribution-based sampling approach, the process may allow for flexibility in layer matching while still favoring pairings with lower KL divergence values. At 242, method 230 determines if there are any unpaired student layers remaining. If unpaired student layers remain, method 230 returns to 232 to select another student layer. If no unpaired student layers remain, method 230 proceeds to 244 and outputs the student-teacher layer pairs (iₛ,iₗ).

In one or more embodiments, a temperature annealing approach is employed during layer-wise knowledge distillation. At the start of training, with a high temperature, the sampling distribution is nearly uniform, giving all possible teacher layers a similar probability of being paired with the selected student layer iₛ, regardless of KL divergence values. This may promote diverse exploration of layer pairings. As the temperature decreases over a number of training iterations, the sampling distribution becomes increasingly influenced by the KL divergence values. Possible teacher layers corresponding to lower KL divergence values gradually become more likely to be paired with student layer iₛ. Towards the end of training, with a low temperature, the sampling distribution becomes highly concentrated around teacher layers with the lowest KL divergence values, thereby promoting a greedy selection strategy. This temperature annealing approach allows the adaptive layer matching to transition from exploration to exploitation over the course of training. Early in training, a wide range of teacher-student layer pairings are explored, potentially discovering unexpected but effective matches. As training progresses, the adaptive layer matching increasingly focuses on the most promising pairings identified during exploration at the beginning of training. The temperature annealing strategy thereby facilitates more robust and effective knowledge transfer from the teacher VLM to the student VLM.

FIG. 2E illustrates a block diagram of an example system 250E suitable for use in implementing some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the system 250E is within the scope and spirit of embodiments of the present disclosure.

System 250E is suitable for use in performing layer-wise knowledge distillation, e.g., by performing method 210 of FIG. 2C and method 230 of FIG. 2D. System 250E includes a memory 251 that stores parameters 252 and training dataset 254, a teacher VLM backbone with verbalizers 260A, a student VLM backbone with verbalizers 260B, optimization processing circuitry 270, and layer pairing processing circuitry 280.

In various embodiments, memory 251 includes volatile memory, non-volatile memory, or a combination thereof. In one or more embodiments, memory 251 stores program code that, when executed, implements the functionality of the teacher VLM backbone with verbalizers 260A and the student VLM backbone with verbalizers 260B. Memory 251 stores parameters 252 that include weights of the teacher VLM backbone with verbalizers 260A and the student VLM backbone with verbalizers 260B (e.g., frozen weights of the teacher VLM backbone and its verbalizers and learnable weights of student VLM backbone and its verbalizers). Memory 251 also stores training dataset 254, which provides input data used to layer-wise knowledge distillation, e.g., by carrying out method 210. In one or more embodiments, training dataset 254 includes pairs of visual and textual inputs.

Teacher VLM backbone with verbalizers 260A and student VLM backbone with verbalizers 260B both process inputs from the training dataset 254 and generate output in response. The outputs include a plurality of outputs (e.g., Nₜ outputs for a teacher VLM having Nₜ layers and corresponding verbalizers and Nₛ outputs for a student VLM having Nₛ layers and corresponding verbalizers). The outputs generated by teacher VLM backbone with verbalizers 260A and by student VLM backbone with verbalizers 260B are provided to layer pairing processing circuitry 280.

Layer pairing processing circuitry 280 pairs layers of student VLM backbone with verbalizers 260B to layers of teacher VLM backbone with verbalizers 260A (e.g., by performing method 230 of FIG. 2D). Optimization processing circuitry 270 evaluates the performance of individual layers of the student VLM backbone by comparing the outputs generated by the verbalizers of the student VLM backbone with the outputs generated by the verbalizers of paired layers of the teacher VLM backbone. Optimization processing circuitry 270 computes, e.g., using a loss function, knowledge distillation losses (KDLs) that quantify the difference between the outputs provided by verbalizers incorporated into the student VLM backbone and outputs provided by verbalizers incorporated into corresponding paired layers of the teacher VLM backbone. Optimization processing circuitry 270 uses the computed losses to compute, via backpropagation, gradients of the computed losses with respect to the learnable weights of the student VLM backbone and of the verbalizers incorporated therein (which are, e.g., stored as a subset of parameters 252), and further uses the computed gradients to compute parameter updates for the learnable weights of the verbalizers. For example, optimization processing circuitry performs steps 220-224 of method 210 of FIG. 2C. In one or more embodiments, layer pairing processing circuitry 280 and optimization processing circuitry 270 can include the same arithmetic logic units, processing cores, and/or processors.

In contrast to the architecture of system 250B of FIG. 2B, the architecture of system 250E is configured for transferring knowledge from a larger model (i.e. the teacher model 260A) to a compact model (i.e., the student model 260B). The introduction of the layer pairing processing circuitry 280 and the use of two distinct VLM backbones (teacher and student) facilitates efficient training of compact vision language models while maintaining high performance.

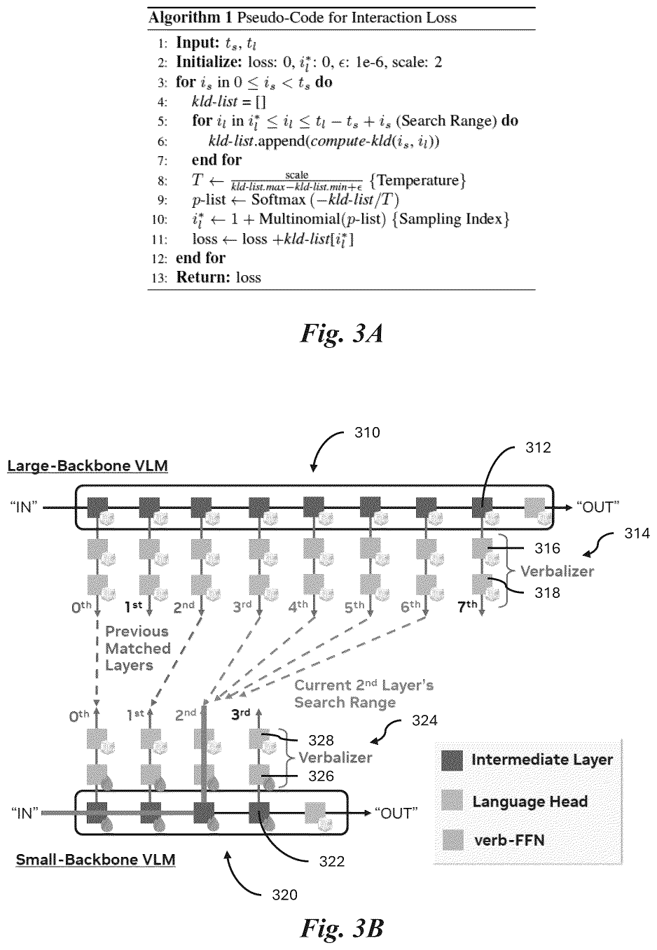

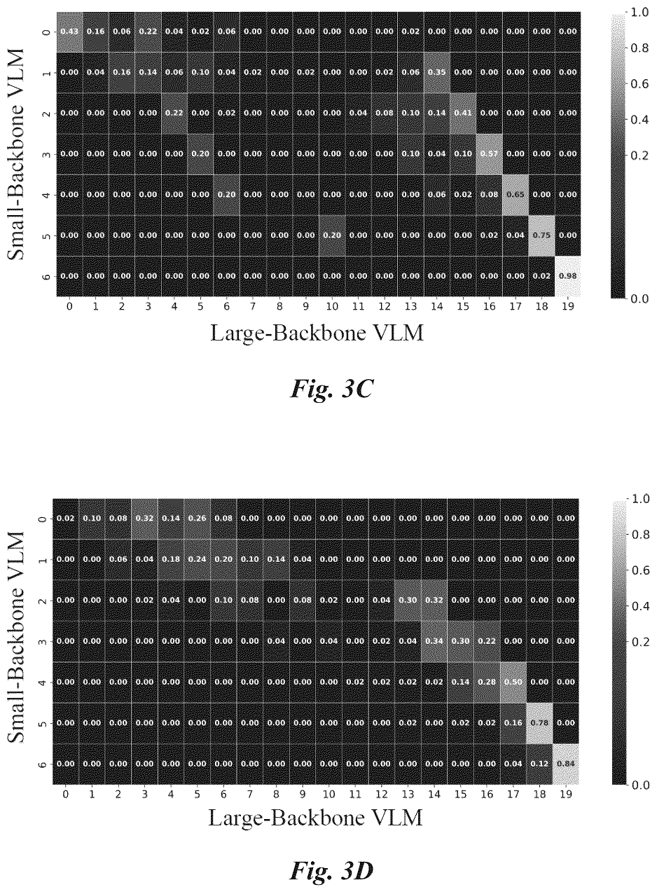

FIG. 3A illustrates pseudo-code for an algorithm for computing layer-wise interaction losses for layer-wise knowledge distillation (e.g., for performing the combination of steps 218 and 220 of method 210 of FIG. 2C). The algorithm of FIG. 3A takes as input the number of target layers in the student VLM (tₛ) and the teacher VLM (tₛ). It initializes the loss to zero, sets an initial teacher layer index

$${i}_{l}^{*} ,$$

and defines hyperparameters ∈ and scale.

The algorithm then iterates over each layer in the student VLM, computing the KL divergence between the student layer and a range of possible teacher layers. The range of possible teacher layers is determined by the current student layer index and the total number of layers in both models. A temperature value T is calculated based on the range of KL divergence values and the hyperparameters e and scale. The temperature T is used to create a probability distribution (plist) by applying the Softmax function to the negative KL divergence values scaled by the temperature. The algorithm then samples a teacher layer index from the distribution and adds the corresponding KL divergence value to the loss. The sampled index becomes the starting point for the next iteration's search range.

The algorithm of FIG. 3A implements an adaptive layer matching strategy, allowing for flexible alignment between student and teacher VLM layers while favoring matches with lower KL divergence values. The use of temperature scaling and multinomial sampling encourages exploration of different layer pairings, potentially leading to more robust knowledge transfer between the models.

FIG. 3B illustrates layer matching for layer-wise knowledge distillation, in accordance with an embodiment. FIG. 3B illustrates interactions between a Large-Backbone VLM 310 and a Small-Backbone VLM 320 (e.g., the teacher VLM backbone with verbalizers 260A and the student VLM backbone with verbalizers 260B, respectively). The Large-Backbone VLM 310 includes a plurality of teacher VLM intermediate layers (e.g., 7^{th} layer 312) arranged in sequence (i.e., an initial 0^{th} layer, a 1^{st} intermediate layer, a 2^{nd} intermediate layer, a 3^{rd} intermediate layer, a 4^{th} intermediate layer, a 5^{th} intermediate layer, a 6^{th} intermediate layer, and a 7^{th} intermediate layer). The output of each teacher VLM intermediate layer is processed by a verbalizer (e.g., verbalizer 314) that includes a feed forward network (e.g., FFN 316) and a language head (e.g., language head 318). The Small-Backbone VLM 320 includes a plurality of student VLM intermediate layers (e.g., 3^{rd} layer 322) arranged in a sequence (i.e., an initial 0^{th} layer, a 1^{st} intermediate layer, a 2^{nd} intermediate layer, and a 3^{rd} intermediate layer). The output of each student VLM intermediate layer is processed by a verbalizer (e.g., verbalizer 324) that includes a feed-forward network (e.g., FFN 326) and a language head (e.g., language head 328). During layer-wise knowledge distillation depicted in FIG. 3B, parameters of the plurality of teacher VLM intermediate layers (including 7^{th} layer 312) and parameters of the verbalizers integrated therewith (including parameters of FFN 316 and parameters of language head 318 of verbalizer 314) remain frozen, while parameters of the plurality of student VLM intermediate layers (including 3^{rd} layer 322) and parameters of the FFNs (including FFN 326) of the verbalizers integrated therewith (including verbalizer 324) are updated.

FIG. 3B illustrates pairing of layers of both VLMs. The initial layer 0^{th} layer of the Small-Backbone VLM is paired with the initial 0^{th} layer of the Large-Backbone VLM, and the 1^{st} intermediate layer of the Small-Backbone VLM is paired with the 2^{nd} intermediate layer of the Large-Backbone VLM. A current search range for the 2^{nd} intermediate layer of the Small-Backbone VLM includes the 3^{rd} through 6^{th} intermediate layers of the Large-Backbone VLM (ensuring that a possible pairing will remain for the 3^{rd} intermediate layer of the Small-Backbone VLM). This approach ensures that the matched layer in the Large-Backbone VLM is always at a deeper or equal position compared to the previously matched layer, maintaining the order of knowledge transfer (as indicated by a flow of information from an input (“IN”) to an output (“OUT”) through both VLM structures).

FIGS. 3C and 3D provide layer-matching probability distributions between student VLM layers and teacher VLM layers before and after, respectively, a layer-wise knowledge distillation process according to an embodiment. In FIGS. 3C and 3D, shading represents the probability of pairing between layers (with lighter shading indicating a higher probabilities of pairing and darker shading indicating lower probabilities of pairing). Student VLM layers (i.e., Small-Backbone VLM layers 0 through 6) are shown on the vertical axis, while teacher VLM layers (i.e., Large-Backbone VLM layers 0 through 20) are shown on the horizontal axis. Comparing FIG. 3C, which represents the probability distribution at the beginning of training, with FIG. 3D, which represents the probability distribution at the end of training, demonstrates that the layer-wise knowledge distillation process according to an embodiment of the present disclosure facilitates exploration of different student-teacher layer pairs and, eventually, a transfer of knowledge from middle layers of the teacher VLM to initial layers of the student VLM along with a transfer of knowledge from terminal layers of the teacher VLM to terminal layers of the student VLM.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

### Parallel Processing Architecture

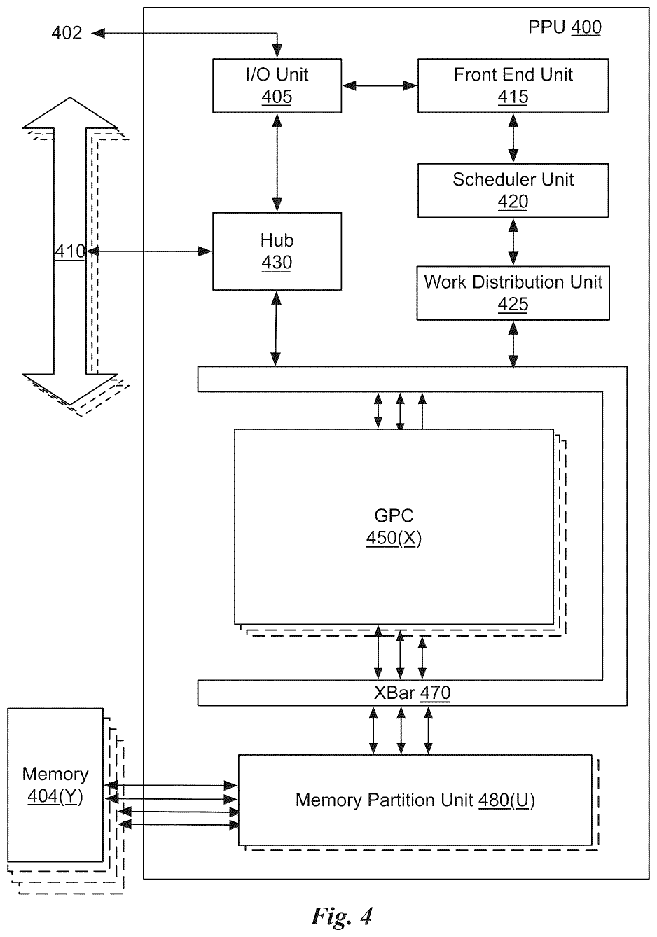

FIG. 4 illustrates a parallel processing unit (PPU) 400, in accordance with an embodiment. The PPU 400 may be used to implement one or more components of systems 250B and 250E of FIGS. 2B and 2E. The PPU 400 may be used to performs one or more steps of methods 200, 210, and 230.

In an embodiment, the PPU 400 is a multi-threaded processor that is implemented on one or more integrated circuit devices. The PPU 400 is a latency hiding architecture designed to process many threads in parallel. A thread (e.g., a thread of execution) is an instantiation of a set of instructions configured to be executed by the PPU 400. In an embodiment, the PPU 400 is a graphics processing unit (GPU) configured to implement a graphics rendering pipeline for processing three-dimensional (3D) graphics data in order to generate two-dimensional (2D) image data for display on a display device. In other embodiments, the PPU 400 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more PPUs 400 may be configured to accelerate thousands of High Performance Computing (HPC), data center, cloud computing, and machine learning applications. The PPU 400 may be configured to accelerate numerous deep learning systems and applications for autonomous vehicles, simulation, computational graphics such as ray or path tracing, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 4, the PPU 400 includes an Input/Output (I/O) unit 405, a front end unit 415, a scheduler unit 420, a work distribution unit 425, a hub 430, a crossbar (Xbar) 470, one or more general processing clusters (GPCs) 450, and one or more memory partition units 480. The PPU 400 may be connected to a host processor or other PPUs 400 via one or more high-speed NVLink 410 interconnect. The PPU 400 may be connected to a host processor or other peripheral devices via an interconnect 402. The PPU 400 may also be connected to a local memory 404 comprising a number of memory devices. In an embodiment, the local memory may comprise a number of dynamic random access memory (DRAM) devices. The DRAM devices may be configured as a high-bandwidth memory (HBM) subsystem, with multiple DRAM dies stacked within each device.

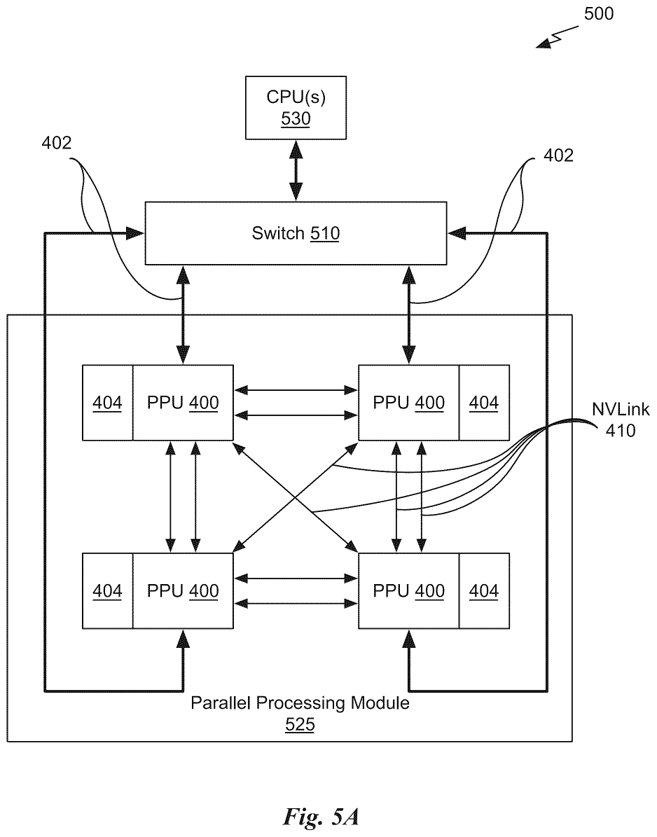

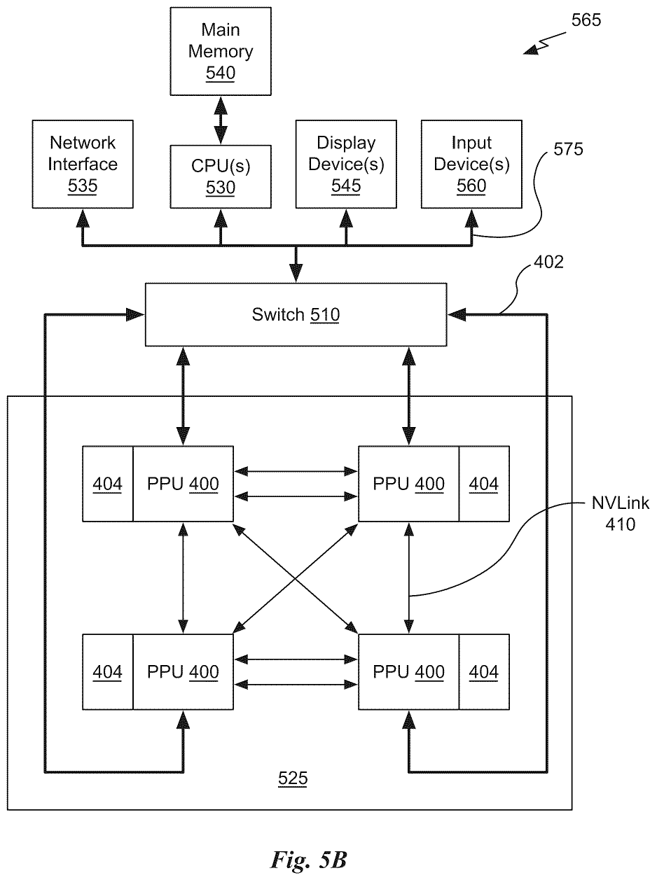

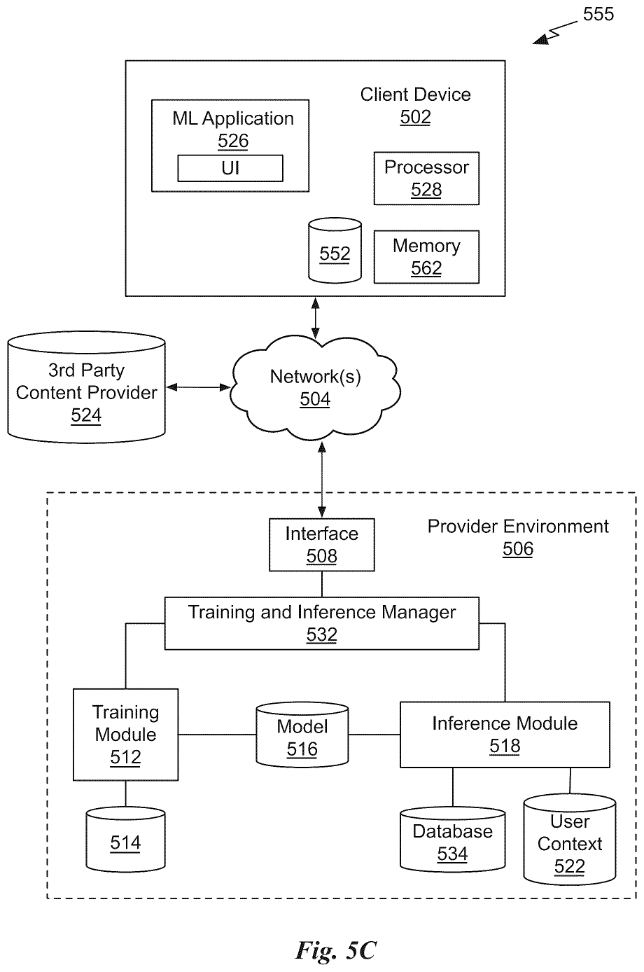

The NVLink 410 interconnect enables systems to scale and include one or more PPUs 400 combined with one or more CPUs, supports cache coherence between the PPUs 400 and CPUs, and CPU mastering. Data and/or commands may be transmitted by the NVLink 410 through the hub 430 to/from other units of the PPU 400 such as one or more copy engines, a video encoder, a video decoder, a power management unit, etc. (not explicitly shown). The NVLink 410 is described in more detail in conjunction with FIG. 5B.

The I/O unit 405 is configured to transmit and receive communications (e.g., commands, data, etc.) from a host processor (not shown) over the interconnect 402. The I/O unit 405 may communicate with the host processor directly via the interconnect 402 or through one or more intermediate devices such as a memory bridge. In an embodiment, the I/O unit 405 may communicate with one or more other processors, such as one or more the PPUs 400 via the interconnect 402. In an embodiment, the I/O unit 405 implements a Peripheral Component Interconnect Express (PCIe) interface for communications over a PCIe bus and the interconnect 402 is a PCIe bus. In alternative embodiments, the I/O unit 405 may implement other types of well-known interfaces for communicating with external devices.

The I/O unit 405 decodes packets received via the interconnect 402. In an embodiment, the packets represent commands configured to cause the PPU 400 to perform various operations. The I/O unit 405 transmits the decoded commands to various other units of the PPU 400 as the commands may specify. For example, some commands may be transmitted to the front end unit 415. Other commands may be transmitted to the hub 430 or other units of the PPU 400 such as one or more copy engines, a video encoder, a video decoder, a power management unit, etc. (not explicitly shown). In other words, the I/O unit 405 is configured to route communications between and among the various logical units of the PPU 400.

In an embodiment, a program executed by the host processor encodes a command stream in a buffer that provides workloads to the PPU 400 for processing. A workload may comprise several instructions and data to be processed by those instructions. The buffer is a region in a memory that is accessible (e.g., read/write) by both the host processor and the PPU 400. For example, the I/O unit 405 may be configured to access the buffer in a system memory connected to the interconnect 402 via memory requests transmitted over the interconnect 402. In an embodiment, the host processor writes the command stream to the buffer and then transmits a pointer to the start of the command stream to the PPU 400. The front end unit 415 receives pointers to one or more command streams. The front end unit 415 manages the one or more streams, reading commands from the streams and forwarding commands to the various units of the PPU 400.

The front end unit 415 is coupled to a scheduler unit 420 that configures the various GPCs 450 to process tasks defined by the one or more streams. The scheduler unit 420 is configured to track state information related to the various tasks managed by the scheduler unit 420. The state may indicate which GPC 450 a task is assigned to, whether the task is active or inactive, a priority level associated with the task, and so forth. The scheduler unit 420 manages the execution of a plurality of tasks on the one or more GPCs 450.

The scheduler unit 420 is coupled to a work distribution unit 425 that is configured to dispatch tasks for execution on the GPCs 450. The work distribution unit 425 may track a number of scheduled tasks received from the scheduler unit 420. In an embodiment, the work distribution unit 425 manages a pending task pool and an active task pool for each of the GPCs 450. As a GPC 450 finishes the execution of a task, that task is evicted from the active task pool for the GPC 450 and one of the other tasks from the pending task pool is selected and scheduled for execution on the GPC 450. If an active task has been idle on the GPC 450, such as while waiting for a data dependency to be resolved, then the active task may be evicted from the GPC 450 and returned to the pending task pool while another task in the pending task pool is selected and scheduled for execution on the GPC 450.

In an embodiment, a host processor executes a driver kernel that implements an application programming interface (API) that enables one or more applications executing on the host processor to schedule operations for execution on the PPU 400. In an embodiment, multiple compute applications are simultaneously executed by the PPU 400 and the PPU 400 provides isolation, quality of service (QoS), and independent address spaces for the multiple compute applications. An application may generate instructions (e.g., API calls) that cause the driver kernel to generate one or more tasks for execution by the PPU 400. The driver kernel outputs tasks to one or more streams being processed by the PPU 400. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. The tasks may be allocated to one or more processing units within a GPC 450 and instructions are scheduled for execution by at least one warp.

The work distribution unit 425 communicates with the one or more GPCs 450 via XBar 470. The XBar 470 is an interconnect network that couples many of the units of the PPU 400 to other units of the PPU 400. For example, the XBar 470 may be configured to couple the work distribution unit 425 to a particular GPC 450. Although not shown explicitly, one or more other units of the PPU 400 may also be connected to the XBar 470 via the hub 430.

The tasks are managed by the scheduler unit 420 and dispatched to a GPC 450 by the work distribution unit 425. The GPC 450 is configured to process the task and generate results. The results may be consumed by other tasks within the GPC 450, routed to a different GPC 450 via the XBar 470, or stored in the memory 404. The results can be written to the memory 404 via the memory partition units 480, which implement a memory interface for reading and writing data to/from the memory 404. The results can be transmitted to another PPU 400 or CPU via the NVLink 410. In an embodiment, the PPU 400 includes a number U of memory partition units 480 that is equal to the number of separate and distinct memory devices of the memory 404 coupled to the PPU 400. Each GPC 450 may include a memory management unit to provide translation of virtual addresses into physical addresses, memory protection, and arbitration of memory requests. In an embodiment, the memory management unit provides one or more translation lookaside buffers (TLBs) for performing translation of virtual addresses into physical addresses in the memory 404.

In an embodiment, the memory partition unit 480 includes a Raster Operations (ROP) unit, a level two (L2) cache, and a memory interface that is coupled to the memory 404. The memory interface may implement 32, 64, 128, 1024-bit data buses, or the like, for high-speed data transfer. The PPU 400 may be connected to up to Y memory devices, such as high bandwidth memory stacks or graphics double-data-rate, version 5, synchronous dynamic random access memory, or other types of persistent storage. In an embodiment, the memory interface implements an HBM2 memory interface and Y equals half U. In an embodiment, the HBM2 memory stacks are located on the same physical package as the PPU 400, providing substantial power and area savings compared with conventional GDDR5 SDRAM systems. In an embodiment, each HBM2 stack includes four memory dies and Y equals 4, with each HBM2 stack including two 128-bit channels per die for a total of 8 channels and a data bus width of 1024 bits.

In an embodiment, the memory 404 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 400 process very large datasets and/or run applications for extended periods.

In an embodiment, the PPU 400 implements a multi-level memory hierarchy. In an embodiment, the memory partition unit 480 supports a unified memory to provide a single unified virtual address space for CPU and PPU 400 memory, enabling data sharing between virtual memory systems. In an embodiment the frequency of accesses by a PPU 400 to memory located on other processors is traced to ensure that memory pages are moved to the physical memory of the PPU 400 that is accessing the pages more frequently. In an embodiment, the NVLink 410 supports address translation services allowing the PPU 400 to directly access a CPU's page tables and providing full access to CPU memory by the PPU 400.

In an embodiment, copy engines transfer data between multiple PPUs 400 or between PPUs 400 and CPUs. The copy engines can generate page faults for addresses that are not mapped into the page tables. The memory partition unit 480 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 404 or other system memory may be fetched by the memory partition unit 480 and stored in the L2 cache 460, which is located on-chip and is shared between the various GPCs 450. As shown, each memory partition unit 480 includes a portion of the L2 cache associated with a corresponding memory 404. Lower level caches may then be implemented in various units within the GPCs 450. For example, each of the processing units within a GPC 450 may implement a level one (L1) cache. The L1 cache is private memory that is dedicated to a particular processing unit. The L2 cache 460 is coupled to the memory interface 470 and the XBar 470 and data from the L2 cache may be fetched and stored in each of the L1 caches for processing.

In an embodiment, the processing units within each GPC 450 implement a SIMD (Single-Instruction, Multiple-Data) architecture where each thread in a group of threads (e.g., a warp) is configured to process a different set of data based on the same set of instructions. All threads in the group of threads execute the same instructions. In another embodiment, the processing unit implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

Each processing unit includes a large number (e.g., 128, etc.) of distinct processing cores (e.g., functional units) that may be fully-pipelined, single-precision, double-precision, and/or mixed precision and include a floating point arithmetic logic unit and an integer arithmetic logic unit. In an embodiment, the floating point arithmetic logic units implement the IEEE 754-2008 standard for floating point arithmetic. In an embodiment, the cores include 64 single-precision (32-bit) floating point cores, 64 integer cores, 32 double-precision (64-bit) floating point cores, and 8 tensor cores.

Tensor cores configured to perform matrix operations. In particular, the tensor cores are configured to perform deep learning matrix arithmetic, such as GEMM (matrix-matrix multiplication) for convolution operations during neural network training and inferencing. In an embodiment, each tensor core operates on a 4×4 matrix and performs a matrix multiply and accumulate operation D=A×B+C, where A, B, C, and D are 4×4 matrices.

In an embodiment, the matrix multiply inputs A and B may be integer, fixed-point, or floating point matrices, while the accumulation matrices C and D may be integer, fixed-point, or floating point matrices of equal or higher bitwidths. In an embodiment, tensor cores operate on one, four, or eight bit integer input data with 32-bit integer accumulation. The 8-bit integer matrix multiply requires 1024 operations and results in a full precision product that is then accumulated using 32-bit integer addition with the other intermediate products for a 8×8×16 matrix multiply. In an embodiment, tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each processing unit may also comprise M special function units (SFUs) that perform special functions (e.g., attribute evaluation, reciprocal square root, and the like). In an embodiment, the SFUs may include a tree traversal unit configured to traverse a hierarchical tree data structure. In an embodiment, the SFUs may include texture unit configured to perform texture map filtering operations. In an embodiment, the texture units are configured to load texture maps (e.g., a 2D array of texels) from the memory 404 and sample the texture maps to produce sampled texture values for use in shader programs executed by the processing unit. In an embodiment, the texture maps are stored in shared memory that may comprise or include an L1 cache. The texture units implement texture operations such as filtering operations using mip-maps (e.g., texture maps of varying levels of detail). In an embodiment, each processing unit includes two texture units.

Each processing unit also comprises N load store units (LSUs) that implement load and store operations between the shared memory and the register file. Each processing unit includes an interconnect network that connects each of the cores to the register file and the LSU to the register file, shared memory. In an embodiment, the interconnect network is a crossbar that can be configured to connect any of the cores to any of the registers in the register file and connect the LSUs to the register file and memory locations in shared memory.

The shared memory is an array of on-chip memory that allows for data storage and communication between the processing units and between threads within a processing unit. In an embodiment, the shared memory comprises 128 KB of storage capacity and is in the path from each of the processing units to the memory partition unit 480. The shared memory can be used to cache reads and writes. One or more of the shared memory, L1 cache, L2 cache, and memory 404 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory enables the shared memory to function as a high-throughput conduit for streaming data while simultaneously providing high-bandwidth and low-latency access to frequently reused data.

When configured for general purpose parallel computation, a simpler configuration can be used compared with graphics processing. Specifically, fixed function graphics processing units, are bypassed, creating a much simpler programming model. In the general purpose parallel computation configuration, the work distribution unit 425 assigns and distributes blocks of threads directly to the processing units within the GPCs 450. Threads execute the same program, using a unique thread ID in the calculation to ensure each thread generates unique results, using the processing unit(s) to execute the program and perform calculations, shared memory to communicate between threads, and the LSU to read and write global memory through the shared memory and the memory partition unit 480. When configured for general purpose parallel computation, the processing units can also write commands that the scheduler unit 420 can use to launch new work on the processing units.

The PPUs 400 may each include, and/or be configured to perform functions of, one or more processing cores and/or components thereof, such as Tensor Cores (TCs), Tensor Processing Units (TPUs), Pixel Visual Cores (PVCs), Ray Tracing (RT) Cores, Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The PPU 400 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 400 is embodied on a single semiconductor substrate. In another embodiment, the PPU 400 is included in a system-on-a-chip (SoC) along with one or more other devices such as additional PPUs 400, the memory 404, a reduced instruction set computer (RISC) CPU, a memory management unit (MMU), a digital-to-analog converter (DAC), and the like.

In an embodiment, the PPU 400 may be included on a graphics card that includes one or more memory devices. The graphics card may be configured to interface with a PCIe slot on a motherboard of a desktop computer. In yet another embodiment, the PPU 400 may be an integrated graphics processing unit (iGPU) or parallel processor included in the chipset of the motherboard. In yet another embodiment, the PPU 400 may be realized in reconfigurable hardware. In yet another embodiment, parts of the PPU 400 may be realized in reconfigurable hardware.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 5A is a conceptual diagram of a processing system 500 implemented using the PPU 400 of FIG. 4, in accordance with an embodiment. The exemplary system 565 may be configured, e.g., to implement method 200 shown in FIG. 2A, method 210 shown in FIG. 2C, and/or method 230 shown in FIG. 2D. The processing system 500 includes a CPU 530, switch 510, and multiple PPUs 400, and respective memories 404.

The NVLink 410 provides high-speed communication links between each of the PPUs 400. Although a particular number of NVLink 410 and interconnect 402 connections are illustrated in FIG. 5B, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 5A, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 5A, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

FIG. 5B illustrates an exemplary system 565 in which the various architecture and/or functionality of the various previous embodiments may be implemented. The exemplary system 565 may be configured, e.g., to implement method 200 shown in FIG. 2A, method 210 shown in FIG. 2C, and/or method 230 shown in FIG. 2D.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5C are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5C is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5C.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage 610 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 5A and/or exemplary system 565 of FIG. 5B—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 5B and/or exemplary system 565 of FIG. 5C. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5C illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 300 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506.

In at least one embodiment, supervised and/or unsupervised training can be performed by the client device 502 and/or the provider environment 506. In at least one embodiment, a set of training data 514 (e.g., classified or labeled data) is provided as input to function as training data.

In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache 460 and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

A graphics processing pipeline may be implemented via an application executed by a host processor, such as a CPU. In an embodiment, a device driver may implement an application programming interface (API) that defines various functions that can be utilized by an application in order to generate graphical data for display. The device driver is a software program that includes a plurality of instructions that control the operation of the PPU 400. The API provides an abstraction for a programmer that lets a programmer utilize specialized graphics hardware, such as the PPU 400, to generate the graphical data without requiring the programmer to utilize the specific instruction set for the PPU 400. The application may include an API call that is routed to the device driver for the PPU 400. The device driver interprets the API call and performs various operations to respond to the API call. In some instances, the device driver may perform operations by executing instructions on the CPU. In other instances, the device driver may perform operations, at least in part, by launching operations on the PPU 400 utilizing an input/output interface between the CPU and the PPU 400. In an embodiment, the device driver is configured to implement the graphics processing pipeline utilizing the hardware of the PPU 400.

Various programs may be executed within the PPU 400 in order to implement the various stages of the graphics processing pipeline. For example, the device driver may launch a kernel on the PPU 400 to perform a vertex shading stage on one processing unit (or multiple processing units). The device driver (or the initial kernel executed by the PPU 400) may also launch other kernels on the PPU 400 to perform other stages of the graphics processing pipeline, such as a geometry shading stage and a fragment shading stage. In addition, some of the stages of the graphics processing pipeline may be implemented on fixed unit hardware such as a rasterizer or a data assembler implemented within the PPU 400. It will be appreciated that results from one kernel may be processed by one or more intervening fixed function hardware units before being processed by a subsequent kernel on a processing unit.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA Geforce Now (GFN), Google Stadia, and the like.

### Example Streaming System

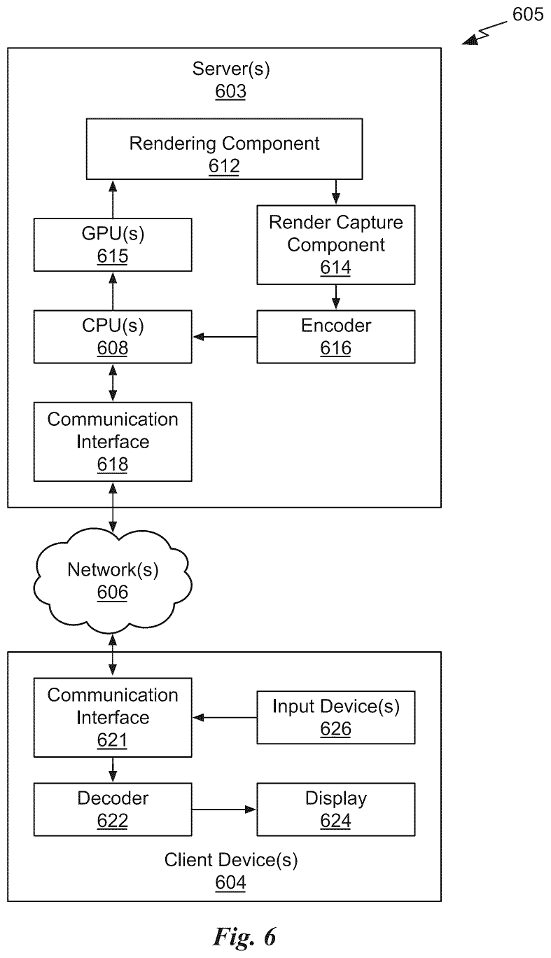

FIG. 6 is an example system diagram for a streaming system 605, in accordance with some embodiments of the present disclosure. FIG. 6 includes server(s) 603 (which may include similar components, features, and/or functionality to the example processing system 500 of FIG. 5A and/or exemplary system 565 of FIG. 5B), client device(s) 604 (which may include similar components, features, and/or functionality to the example processing system 500 of FIG. 5A and/or exemplary system 565 of FIG. 5B), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

It should be understood that the arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A method for training a compact vision language model (VLM) via distillation from a teacher VLM, the method comprising:
obtaining an initial compact VLM including a plurality of compact VLM intermediate layers;
obtaining the teacher VLM, the teacher VLM comprising a plurality of teacher VLM intermediate layers; and
performing, for each of a plurality of training iterations:
adaptive layer matching to establish a plurality of student-teacher layer pairs, each student-teacher layer pair comprising a compact VLM intermediate layer and a teacher VLM intermediate layer;
student-teacher layer pair knowledge distillation loss computation to compute, for one or more student-teacher layer pairs, one or more knowledge distillation losses; and
student VLM parameter updating to update, for one or more compact VLM intermediate layers, learnable parameters based on the one or more knowledge distillation losses.

2. The method of claim 1, further comprising:
incorporating verbalizers into one or more of the plurality of compact VLM intermediate layers of the initial compact VLM;
incorporating verbalizers into one or more of the plurality of teacher VLM intermediate layers; and
training the verbalizers incorporated into the initial compact VLM and the verbalizers incorporated into the teacher VLM.

3. The method of claim 2, wherein training the verbalizers incorporated into the initial compact VLM and the verbalizers incorporated into the teacher VLM comprises:
performing, for each of a plurality of training iterations:
generating, by one or more of the verbalizers incorporated into the initial compact VLM and by one or more of the verbalizers incorporated into the teacher VLM, a token space prediction,
computing losses based on the token space predictions and a ground truth, and
updating, based on the computed losses, learnable parameters of the one or more of the verbalizers incorporated into the initial compact VLM and of the one or more of the verbalizers incorporated into the teacher VLM.

4. The method of claim 1, wherein the one or more knowledge distillation losses computed for the one or more student-teacher layer pairs are computed by comparing a token space prediction generated by a respective compact VLM intermediate layer and a token space prediction generated by a respective teacher VLM intermediate layer.

5. The method of claim 4, wherein the knowledge distillation losses are KL divergences.

6. The method of claim 1, wherein the adaptive layer matching comprises determining, for one or more of the plurality of compact VLM intermediate layers, a search range comprising one or more teacher VLM intermediate layers.

7. The method of claim 6, wherein the search range for the one or more of the plurality of compact VLM intermediate layers iₛ=0^{th}, 1^{st}, . . . , (tₛ−1)^{th} layer includes one or more of the plurality of teacher VLM intermediate layers iₗ=0^{th}, 1^{st}, . . . , (tₗ−1)^{th} selected such that a layer iₗ=j paired with a layer of iₛ and a layer iₗ=k paired with a layer of iₛ−1 satisfies j>k.

8. The method of claim 7, wherein a teacher VLM intermediate layer paired with a compact VLM intermediate layer is selected by sampling from a distribution inversely proportional to a KL divergence a token space output of the compact VLM intermediate layer and the token space outputs of the teacher VLM intermediate layers in the search range.

9. The method of claim 8, wherein the distribution is computed using a softmax of a scaled, negative KL divergence values.

10. A system for training a compact vision language model (VLM) via distillation from a teacher VLM, the system comprising:
processing circuitry configured to:
obtain an initial compact VLM including a plurality of compact VLM intermediate layers;
obtain the teacher VLM, the teacher VLM comprising a plurality of teacher VLM intermediate layers; and
perform, for each of a plurality of training iterations:
adaptive layer matching to establish a plurality of student-teacher layer pairs, each student-teacher layer pair comprising a compact VLM intermediate layer and a teacher VLM intermediate layer,
student-teacher layer pair knowledge distillation loss computation to compute, for one or more student-teacher layer pairs, a knowledge distillation loss, and
student VLM parameter updating to update, for one or more compact VLM intermediate layers, learnable parameters based on the one or more knowledge distillation losses; and
one or more memories to store parameters of the compact VLM.

11. The system of claim 10, the processing circuitry further configured to:
incorporate verbalizers into one or more of the plurality of compact VLM intermediate layers of the initial compact VLM;
incorporate verbalizers into one or more of the plurality of teacher VLM intermediate layers; and
train the verbalizers incorporated into the initial compact VLM and the verbalizers incorporated into the teacher VLM.

12. The system of claim 11, wherein the processing circuitry is configured to train the verbalizers incorporated into the initial compact VLM and the verbalizers incorporated into the teacher VLM by performing, for each of a plurality of training iterations:
generating, by one or more of the verbalizers incorporated into the initial compact VLM and by one or more of the verbalizers incorporated into the teacher VLM, a token space prediction,
computing losses based on the token space predictions and a ground truth, and
updating, based on the computed losses, learnable parameters of the one or more of the verbalizers incorporated into the initial compact VLM and of the one or more of the verbalizers incorporated into the teacher VLM.

13. The system of claim 10, wherein the knowledge distillation losses computed for the one or more student-teacher layer pairs are computed by comparing a token space prediction generated by a respective compact VLM intermediate layer and a token space prediction generated by a respective teacher VLM intermediate layer.

14. The system of claim 13, wherein the knowledge distillation losses are KL divergences.

15. The system of claim 10, wherein the adaptive layer matching comprises determining, for one or more of the plurality of compact VLM intermediate layers, a search range comprising one or more teacher VLM intermediate layers.

16. The system of claim 15, wherein the search range for the one or more of the plurality of compact VLM intermediate layers is =0^{th}, 1^{st}, . . . , (tₛ−1)^{th} layer includes one or more of the plurality of teacher VLM intermediate layers iₗ=0^{th}, 1^{st}, . . . , (tₗ−1)^{th} selected such that a layer iₗ=j paired with a layer of iₛ and a layer iₗ=k paired with a layer of iₛ−1 satisfies j>k.

17. The system of claim 16, wherein a teacher VLM intermediate layer paired with a compact VLM intermediate layer is selected by sampling from a distribution inversely proportional to a KL divergence a token space output of the compact VLM intermediate layer and the token space outputs of the teacher VLM intermediate layers in the search range.

18. The system of claim 17, wherein the distribution is computed using a softmax of a scaled, negative KL divergence values.

19. A non-transitory computer readable medium having stored thereon processor executable instructions that, when executed by processing circuitry, cause the processing circuitry to perform a method for training a compact vision language model (VLM) via distillation from a teacher VLM, the method comprising:
obtaining an initial compact VLM including a plurality of compact VLM intermediate layers;
obtaining the teacher VLM, the teacher VLM comprising a plurality of teacher VLM intermediate layers; and
performing, for each of a plurality of training iterations:
adaptive layer matching to establish a plurality of student-teacher layer pairs, each student-teacher layer pair comprising a compact VLM intermediate layer and a teacher VLM intermediate layer;
student-teacher layer pair knowledge distillation loss computation to compute, for one or more student-teacher layer pairs, a knowledge distillation loss; and
student VLM parameter updating to update, for one or more compact VLM intermediate layers, learnable parameters based on the one or more knowledge distillation losses.

20. The non-transitory computer readable medium according to claim 19, the method further comprising:
incorporating verbalizers into one or more of the plurality of compact VLM intermediate layers of the initial compact VLM;
incorporating verbalizers into one or more of the plurality of teacher VLM intermediate layers; and
training the verbalizers incorporated into the initial compact VLM and the verbalizers incorporated into the teacher VLM.
